(19) United States
(12) Patent Application Publication
(10) Pub. No.: US 2005/0252250 A1
(43) Pub. Date: Nov. 17, 2005

(54) Apparatus and method for controlling steam generating unit of washing machine

(75) Inventors: Soo-Young Oh, Seoul (KR); Kyung-Chul Woo, Seoul (KR); Yang-Hoon Chung, Incheon (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/127,176

(22) Filed: May 12, 2005

(30) Foreign Application Priority Data
May 13, 2004 (KR) 10-2004-33964

(51) Int. Cl. D06F 33/00; B08B 7/04

(52) U.S. Cl. 68/12.03; 8/149.2; 8/149.3; 68/12.02; 68/12.04; 68/12.22; 68/207; 68/15

(57) ABSTRACT

An apparatus for controlling steam generating unit of washing machine is disclosed to reduce power consumption of the washing machine by correcting a temperature value detected by a temperature sensor installed in the washing machine to be the same as an actual temperature value of the laundry. The apparatus for controlling steam generating unit of washing machine includes a correcting unit for correcting a temperature value detected by a temperature sensor installed in the washing machine based on a pre-set temperature correction coefficient according to the weight of the laundry inside the washing machine; and a controller for controlling power applied to a steam generating unit in the washing machine.

### BACKGROUND OF THE INVENTION

1. Field of the Invention

The present invention relates to a washing machine and, more particularly, to an apparatus for controlling a steam generating unit of a washing machine and its method.

2. Description of the Prior Art

In general, a washing machine is a device for washing the laundry by performing a washing, rinsing and dewatering stroke. The washing machine is divided into several types such as a pulsator type, an agitation type, a drum type, and the like, according to a washing method.

FIG. 1 is a sectional view showing the construction of a washing machine in accordance with a prior art.

As shown in FIG. 1, the washing machine includes a casing 17, a tub 12 disposed inside the casing 17, and drum 13 rotatably disposed inside the tub 12.

A door 26 is installed at a front surface of the casing 17 and allows entry of laundry. A support spring 14 and a damper 23 are installed at upper and lower sides of the tub 12 installed inside the casing 17, respectively, in order to buffer and support the tub 12.

A drum driving motor 18 is installed at a rear side of the tub 12 in order to rotate the drum 13.

At an upper side of the tub 12, there are provided a detergent box 11 for supplying detergent, a water supply pipe 15 and a water supply valve 16 for supplying washing water. A drain pump 14 for discharging washing water through an drain pipe 22 is installed at a lower side of the tub 12.

Also, at the lower side of the tub 12, a heater chamber 21 and a heater 20 are installed to heat washing water received in the tub 12, and a temperature sensor 19 for sensing a temperature. A plurality of lifts 25 are installed inside the drum 13 in order to move upwardly the laundry and then dropping it to the lower side.

When laundry is received inside the drum 13 and detergent and washing water are supplied therein, a controller (not shown) controls the drum driving motor 18 to rotate the drum 13 and circulates washing water to perform a cleaning process.

When the cleaning process is terminated, the controller controls the drain pump 24 and the drum driving motor 18 to perform a draining process and a dewatering process, and then, washing water is supplied into the tub 12 to perform a rinsing process.

The conventional washing machine has such shortcomings that when water received in the heater chamber 21 is heated, detergent remains inside the heater chamber 21, washing water must be additionally supplied into the heater chamber 21, and power is also additionally needed to heat the washing water supplied in the heater chamber 21.

In order to solve such a problem, a steam generating unit is provided in the washing machine. The washing machine having the steam generating unit is advantageous in that steam is sprayed into the drum 13 without using the heater 20 and the heater chamber 21, so that washing water and power consumption can be reduced.

But, the washing machine with the steam generating unit has the following problems. That is, a temperature sensor 19 for sensing an internal temperature is installed at a lower side of the tub 12 and the steam generating unit is installed at the upper side of the tub 12, there occurs a difference between an actual temperature of the laundry or an actual temperature of the washing water and a temperature detected by the temperature sensor 19. Namely, the temperature value detected by the temperature sensor 19 is measured to be lower than the actual temperature of the laundry or the actual temperature of the washing water.

Thus, steam is unnecessarily supplied into the drum 13 due to the temperature difference, for which, thus, power consumption of the washing machine is increased due to the unnecessary steam supply.

### SUMMARY OF THE INVENTION

Therefore, an object of the present invention is to provide an apparatus for controlling a steam generating unit of a washing machine capable of reducing power consumption of the washing machine by correcting a temperature value detected by a temperature sensor installed in the washing machine to be the same as an actual temperature value of the laundry, and its method.

To achieve these and other advantages and in accordance with the purpose of the present invention, as embodied and broadly described herein, there is provided an apparatus for controlling a steam generating unit of a washing machine including: a correcting unit for correcting a temperature value detected by a temperature sensor installed in the washing machine based on a pre-set temperature correction coefficient according to the weight of the laundry inside the washing machine; and a controller for controlling power applied to a steam generating unit in the washing machine.

To achieve the above object, there is also provided an apparatus for controlling a steam generating unit of a washing machine including: a temperature sensor installed at a lower side of a tub of the washing machine and detecting an ambient temperature; a load amount calculating unit for calculating the weight of the laundry inside the washing machine; a temperature correcting unit for correcting a temperature value detected by the temperature sensor so as to be the same as an actual temperature value of the laundry and outputting the corrected temperature value; and a controller electrically connected with the steam generating unit for spraying steam into the washing machine and controlling the steam generating unit based on the corrected temperature value and a pre-set reference temperature value.

To achieve the above object, there is also provided a method for controlling a steam generating unit of a washing machine including: calculating an actual temperature value of the laundry inside the washing machine based on a pre-set temperature correction coefficient according to the weight of the laundry inside the washing machine and a temperature value detected by a temperature sensor installed in the washing machine; and controlling power applied to a steam generating unit in the washing machine based on the calculated temperature value and a pre-set reference temperature value.

To achieve the above object, there is also provided a method for controlling a steam generating unit of a washing machine, which includes a calculating unit for calculating the weight of the laundry received inside a drum of the washing machine, a temperature sensor installed at a lower side of a tub of the washing machine and detecting an ambient temperature when steam is sprayed into the drum, and a steam generating unit for spraying steam into the drum, including: correcting a temperature value detected by the temperature sensor based on a temperature correction coefficient previously set according to the weight of the laundry in order to calculate an actual temperature of the laundry of the washing machine; and cutting off power being applied to the steam generating unit when the corrected temperature value reaches a pre-set reference temperature value.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view showing the construction of a washing machine in accordance with a prior art;

FIG. 2 is a perspective view showing the structure of a washing machine with a steam generating unit in accordance with the present invention;

FIG. 3 is a block diagram showing the construction of an apparatus for controlling the steam generating unit of the washing machine in accordance with the present invention;

FIG. 4A is a graph showing a difference between an actual temperature value of the laundry and a temperature value detected by a temperature sensor when there is a small amount of laundry in a drum of the washing machine;

FIG. 4B is a graph showing an actual temperature value of the laundry when there is a small amount of laundry in the drum of the washing machine and a corrected temperature value;

FIG. 5A is a graph showing a difference between an actual temperature value of the laundry and a temperature value detected by a temperature sensor when there is a large amount of laundry in a drum of the washing machine;

FIG. 5B is a graph showing an actual temperature value of the laundry when there is a large amount of laundry in the drum of the washing machine and a corrected temperature value; and

FIG. 6 is a flow chart of a method for controlling the steam generating unit of the washing machine in accordance with the present invention.

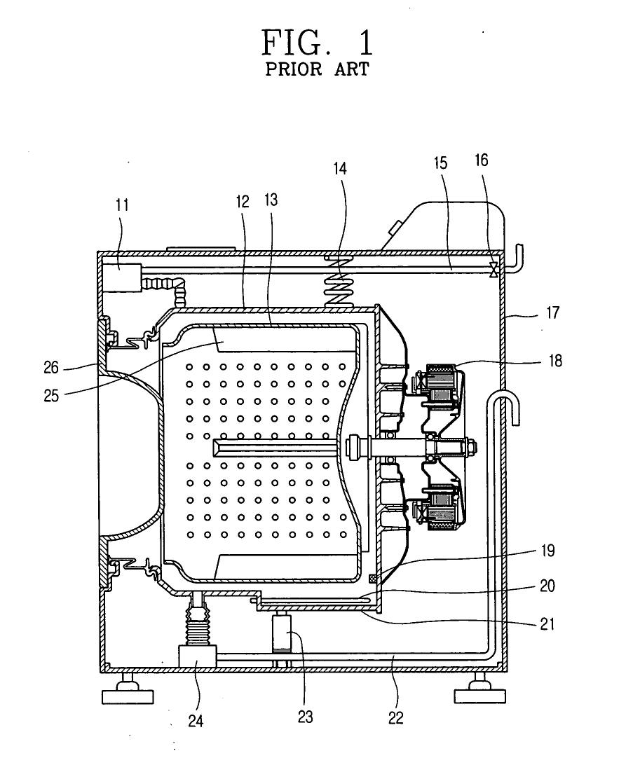

### DETAILED DESCRIPTION OF THE PREFERRED EMBODIMENTS

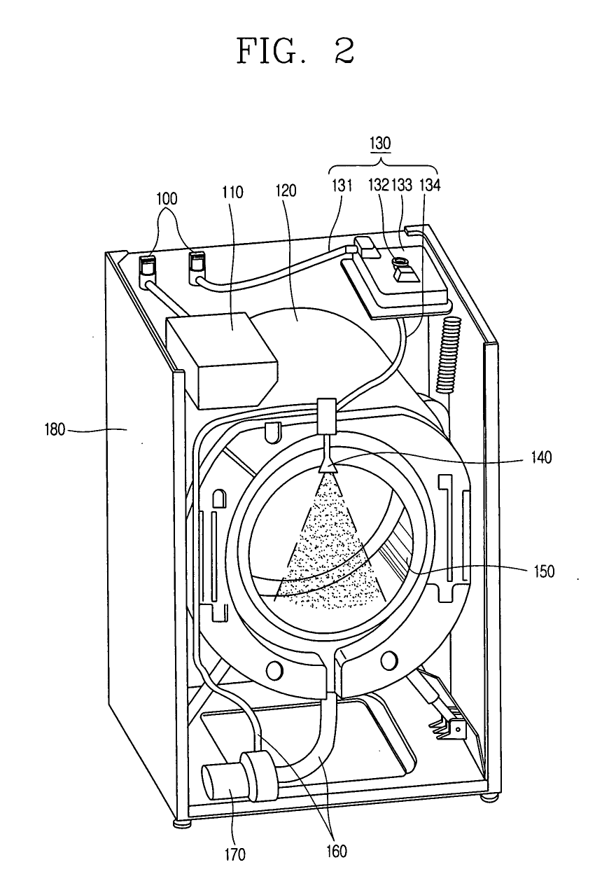

The apparatus for controlling a steam generating unit of a washing machine capable of reducing power consumption of the washing machine by correcting a temperature value detected by a temperature sensor installed in the washing machine to be the same as an actual temperature value of the laundry and its method in accordance with the present invention will now be described with reference to FIGS. 2 to 6.

FIG. 2 is a perspective view showing the structure of a washing machine with a steam generating unit in accordance with the present invention.

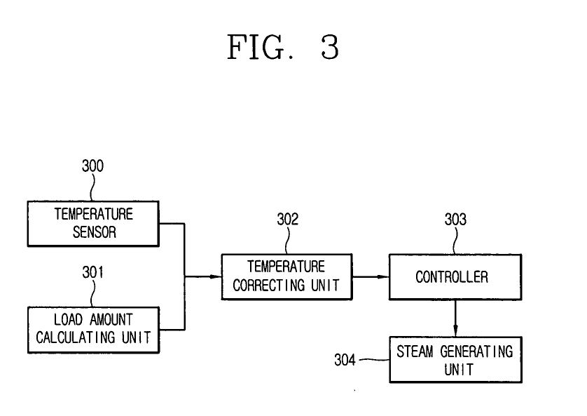

As shown in FIG. 2, the washing machine having the steam generating unit includes: an outer cabinet 180; a tub 120 installed inside the outer cabinet 180 and receiving washing water; a drum 150 installed inside the tub 120 and rotated by a rotational force of an internal motor (not shown) of the washing machine to wash the laundry; a water supply pipe 110 for supplying washing water into the drum 150; a detergent box 110 for supplying detergent into the drum 150; a steam generating unit 130 for supplying steam into the drum 150; an injection nozzle 140 for spraying steam generated in the steam generating unit 130 into the drum 150; a drain pipe 160 for draining washing water out of the drum 150; a circulation pump 170 for pumping washing water drained from the drain pipe 160 and circulating washing water through a cyclic water pipe; a temperature sensor 300 (in FIG. 3) installed at a lower side of the tub 120 and detecting an ambient temperature; and a load amount calculating unit 301 (in FIG. 3) for calculating an amount of load (e.g., the weight of the laundry) received inside the drum 150. Herein, the temperature sensor 300 and the load amount calculating unit 301 are the same as those in the conventional art, descriptions of which are thus omitted.

The steam generating unit 130 includes: a container 133 for storing steam; a heater (not shown) installed in the container 133 and heating water supplied to the container 133 through a pipe 131 connected with the water supply pipe 100 when supplied water reaches a pre-set level, in order to convert it into steam; a drain pipe 134 for draining steam out of the drum 150 of the washing machine through the spray nozzle 140 when steam stored in the container 133 reaches a pre-set pressure; and a water level sensor 132 positioned at a central region of the steam generating unit 130 and controlling a water level of the container 133.

FIG. 3 is a block diagram showing the construction of an apparatus for controlling the steam generating unit of the washing machine in accordance with the present invention.

As shown in FIG. 3, the unit for controlling the steam generating unit in accordance with the present invention includes: a temperature sensor 300 installed at a lower side of the tub 130 and detecting an ambient temperature; a load amount calculating unit 301 for calculating the weight of the laundry received in the drum 150; a temperature correcting unit 303 for correcting a temperature value detected by the temperature sensor 300 so as to be the same as an actual temperature value of the laundry and outputting the corrected temperature value (which is the same as the actual temperature value of the laundry); and a controller 302 electrically connected with the heater (not shown) of the steam generating unit 304 and controlling the heater based on the corrected temperature value and the pre-set reference temperature value.

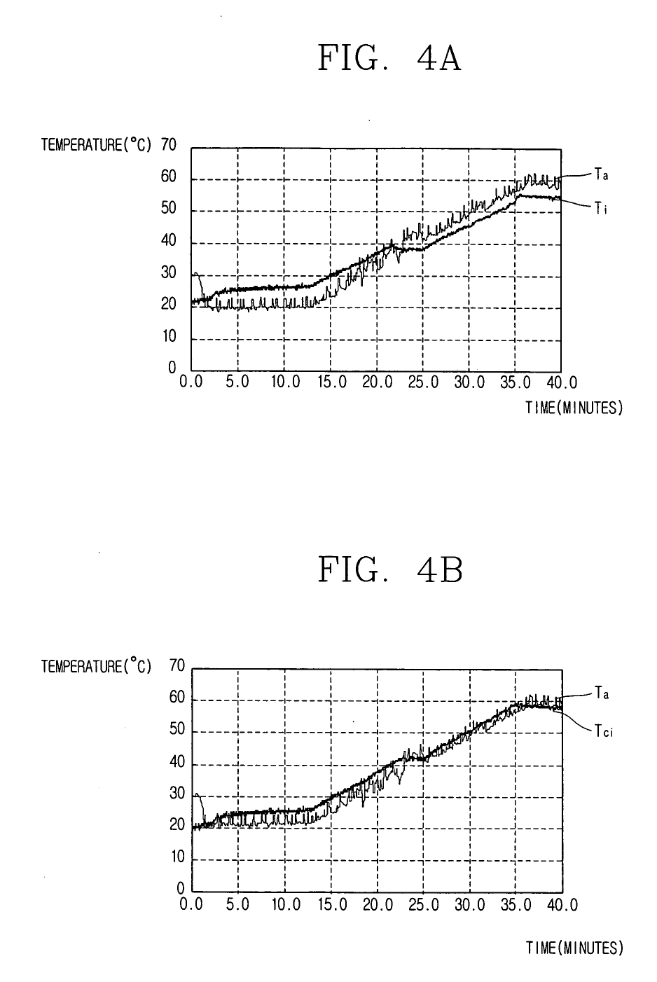

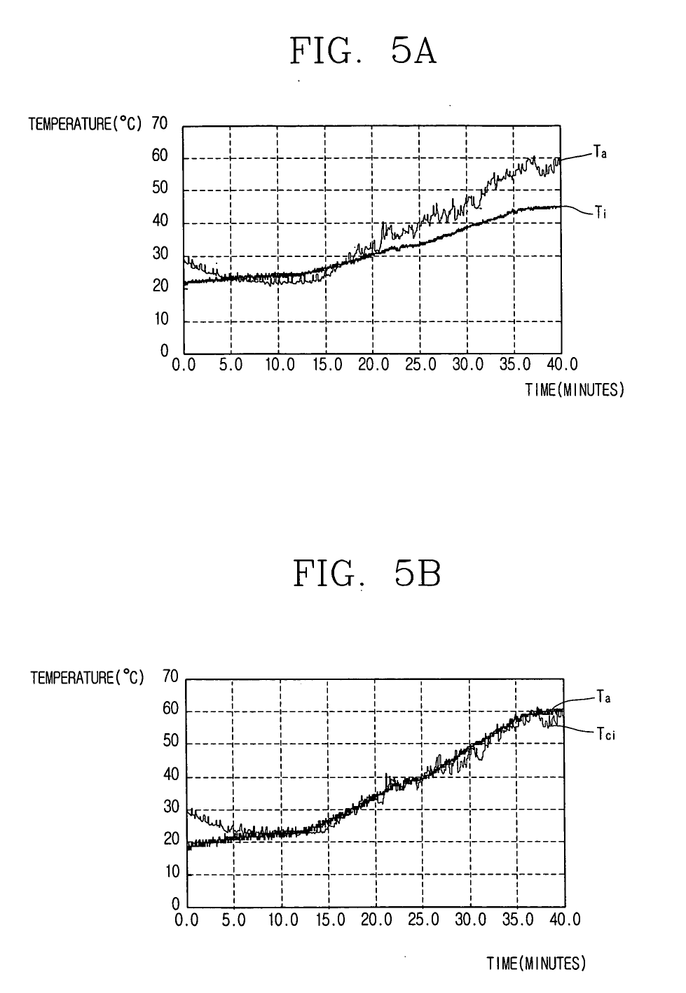

When the corrected temperature value reaches the pre-set reference temperature value, the controller 302 cuts off power being supplied to the heater of the steam generating unit 302 in order to prevent steam supply into the drum 150 and reduce power consumption of the washing machine. Herein, the steam generated from the steam generating unit 130 is sprayed into the drum 150 through the spray nozzle 140, so the temperature value detected by the temperature sensor 300 according to the weight (load amount) of the laundry and the actual temperature value of the laundry are different as shown in FIGS. 4A and 5A. For example, there can be temperature difference by about 5° C.˜15° C. between the actual temperature value of the laundry and the temperature value detected by the temperature sensor 300 according to the weight of the laundry.

FIG. 4A is a graph showing a difference between an actual temperature value of the laundry and a temperature value detected by a temperature sensor when there is a small amount (3 kg) of laundry in a drum of the washing machine.

As shown in FIG. 4A, assuming that a pre-set reference temperature value is 600, the weight of the laundry is 3 kg and the temperature value (Tᵢ) detected by the temperature sensor 300 is 550, an actual temperature value (Tₐ) of the laundry is 600. Namely, because the temperature sensor 300 is installed at the lower side of the tub 12, the temperature value (Tᵢ) detected by the temperature sensor 300 is measured to be lower than the actual temperature value (Tₐ) of the laundry. Herein, the pre-set reference temperature is a temperature value previously set for cutting off power applied to the steam generating unit 304.

FIG. 4B is a graph showing an actual temperature value of the laundry when there is a small amount (e.g., 3 kg) of laundry in the drum of the washing machine and a corrected temperature value.

As shown in FIG. 4B, the temperature correcting unit 302 calculates a corrected temperature value (T_{ci}) based on the temperature value (Tᵢ) detected by the temperature sensor 300 and the pre-set temperature correction coefficient. The corrected temperature value (T_{ci}) is the same as the actual temperature value (Ta) of the laundry. Namely, power consumption of the washing machine can be reduced by controlling the steam generating unit 130 according to the corrected temperature value (T_{ci}) (i.e., the actual temperature value of the laundry) calculated by the temperature correcting unit 302. Herein, the temperature correction coefficient is a pre-set value to be multiplied to a current weight value of the laundry in order to compensate the difference value between the temperature value previously detected by the temperature sensor 300 according to the weight of the laundry and the actual temperature value of the laundry previously measured according to the weight of the laundry.

FIG. 5A is a graph showing a difference between an actual temperature value (Tₐ) of the laundry and a temperature value (Tᵢ) detected by a temperature sensor when there is a large amount (e.g., 5 kg) of laundry in a drum of the washing machine.

As shown in FIG. 5A, assuming that the pre-set reference temperature is 600, the weight of the laundry is 5 kg, and a temperature value (Tᵢ) detected by the temperature sensor 300 is 45° C., an actual temperature value (Tₐ) of the laundry is 60° C.

Namely, because the temperature sensor 300 is installed at the lower side of the tub 12, as the weight of the laundry increases, the temperature value (Tᵢ) detected by the temperature sensor 300 is measured to become gradually lower than the actual temperature value (Tₐ) of the laundry.

FIG. 5B is a graph showing an actual temperature value of the laundry when there is a large amount (e.g., 5 kg) of laundry in the drum of the washing machine and a corrected temperature value.

As shown in FIG. 5B, the temperature correcting unit 302 calculates a corrected temperature value (T_{ci}) based on the temperature value (Ti) detected by the temperature sensor 300 and the pre-set temperature correction coefficient. The corrected temperature value (T_{ci}) is identical to the actual temperature value (Tₐ) of the laundry. Namely, power consumption of the washing machine can be reduced by controlling the steam generating unit 130 according to the calculated corrected temperature value (T_{ci}).

Accordingly, the power consumption of the washing machine can be reduced by controlling the steam generating unit 130 based on the temperature correction coefficient previously set according to the weight of the laundry and the temperature value detected by the temperature sensor 300. Namely, when the corrected temperature value (T_{ci}) identical to the actual temperature value of the laundry reaches the pre-set reference temperature (e.g., 60° C.), power being applied to the heater of the steam generating unit 304 is cut off, so that steam cannot be sprayed into the drum 150 of the washing machine and thus power consumption of the washing machine can be reduced.

The method for controlling the steam generating unit of the washing machine will now be described with reference to FIGS. 4A to 6.

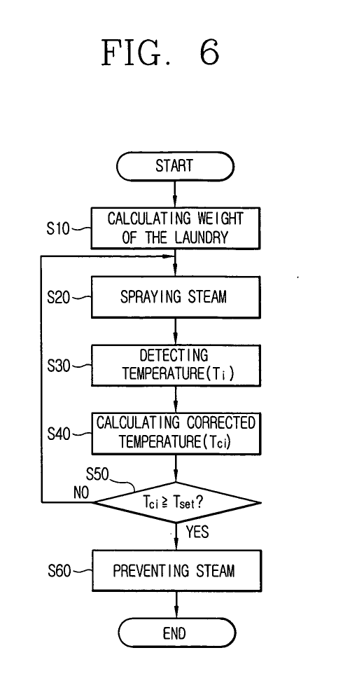

FIG. 6 is a flow chart of a method for controlling the steam generating unit of the washing machine in accordance with the present invention.

First, the load amount calculating unit 301 calculates the weight of the laundry inputted into the drum 150 of the washing machine and outputs the calculated value to the temperature correcting unit 302 (step S10). The load amount calculating unit 301 can calculate the weight of the laundry wet by washing machine or the weight of the dry laundry.

Thereafter, the steam generating unit 304 generates steam by heating water through the internal heater according to a control signal of the controller 303, and sprays the steam into the drum 150 through the spray nozzle 140 (step S20).

As steam is sprayed to the laundry inputted in the drum 150 of the washing machine, the temperature sensor 300 detects a temperature of the lower region of the tub 120 and outputs the detected temperature value (Tᵢ) to the temperature correcting unit 302 (step S30).

The temperature correcting unit 303 calculates an actual temperature value of the laundry based on the temperature value (Tᵢ) detected by the temperature sensor 300 and the temperature correction coefficient (C) previously set according to the weight of the laundry. Namely, it is preferred that the temperature correcting unit 302 calculates the corrected temperature value (T_{ci}) (the actual temperature value of the laundry) through equation (1) shown below such that the corrected temperature value (T_{ci}) can be identical to the actual temperature value of the laundry.

The temperature correcting unit 302 calculates the corrected temperature value (T_{ci}) by substituting a weight value (Lᵢ) of the laundry calculated by the load amount calculating unit 301, the temperature value (Tᵢ) detected by the temperature sensor 300 and the temperature correction coefficient (C) previously set according to the weight of the laundry, and outputs the calculated corrected temperature value (T_{ci}) to the controller (step S40). Herein, the corrected temperature value (T_{ci}) calculated according to equation (1) shown below is identical to the actual temperature value of the laundry.
T_{ci}=Tᵢ+(Lᵢ×C) (1)
wherein Tᵢ is a temperature value currently detected by the temperature sensor 300, Lᵢ is a current weight value of the laundry in the drum of the washing machine, and ‘C’ is a temperature correction coefficient previously set through experimentation for compensating a difference value between the temperature value previously detected by the temperature sensor 300 according to the weight of the laundry and the actual temperature value of the laundry previously measured according to the weight of the laundry. The temperature correction coefficient (C) is thus changed according to the weight of the laundry.

For example, if a temperature value currently detected by the temperature sensor 300 is 55° C. and the weight value of the laundry calculated by the load amount calculating unit 301 is 3 kg, the actual temperature value of the laundry is 60° C. Accordingly, the temperature correcting unit 302 multiplies the pre-set temperature compensation coefficient (1.667) corresponding to the current weight value (3 kg) of the laundry to the current weight value of the laundry, and adds the obtained value to a temperature value (55° C.) currently detected by the temperature sensor 300 to obtain a corrected temperature value (T_{ci}) (60° C.). Herein, the calculated corrected temperature value (T_{ci}) (60° C.) is identical to the actual temperature value (60° C.) of the laundry.

In addition, when a temperature value currently detected by the temperature sensor 300 is 45° C. and a current weight value of the laundry calculated by the load amount calculating unit 301 is 5 kg, an actual temperature value of the laundry is 60° C. Accordingly, the temperature correcting unit 302 multiplies the pre-set temperature compensation coefficient (3) corresponding to the current weight value (5 kg) of the laundry to the current weight value (5) of the laundry, and the obtained value (15° C.) to the temperature value (45° C.) currently detected by the temperature sensor 300 to thereby calculate the corrected temperature value (T_{ci}) (60° C.). Herein, the calculated corrected temperature value (Tci) (60° C.) is identical to the actual temperature value (60° C.) of the laundry.

In this manner, the temperature correcting unit 303 can calculate the actual temperature value of the laundry based on the temperature correction coefficient previously set according to the weight of the laundry in the washing machine and the temperature value detected by the temperature sensor 300 installed in the washing machine.

The controller 302 compares the calculated corrected temperature value (T_{ci}) and the pre-set temperature value (Tₛₑₜ) (e.g., 60° C.) (step S50), and controls the steam generating unit 130 according to the comparison result. For example, when the calculated corrected temperature value (T_{ci}) reaches the pre-set temperature (Tₛₑₜ) (e.g., 60° C.), the controller 303 cuts off power being supplied to the heater of the steam generating unit 304, to thereby prevent steam supply into the drum 150.

If, however, the calculated corrected temperature value (T_{ci}) does not reach the pre-set temperature (Tₛₑₜ) (e.g., 60° C.) (step S50), the controller 302 applies power to the heater of the steam generating unit 304 to continuously supply steam into the drum 150.

As so far described, the apparatus for controlling the steam generating unit of the washing machine and its method in accordance with the present invention have such an advantage that a temperature value detected by the temperature sensor is corrected to be the same as the actual temperature value of the laundry, so power consumption of the washing machine can be reduced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The present disclosure relates to subject matter contained in Korean Application No. 10-2004-0033964, filed on May 13, 2004, the contents of which are herein expressly incorporated by reference in its entirety.

1. An apparatus for controlling a steam generating unit of a washing machine comprising:
a correcting unit for correcting a temperature value detected by a temperature sensor installed in the washing machine based on a pre-set temperature correction coefficient according to the weight of the laundry inside the washing machine; and
a controller for controlling power applied to a steam generating unit in the washing machine based on the corrected temperature value and a pre-set reference temperature value.

2. The apparatus of claim 1, wherein the temperature correction coefficient is a pre-set value to be multiplied to a current weight value of the laundry in order to compensate a difference value between the temperature value previously detected by the temperature sensor according to the weight of the laundry and an actual temperature value of the laundry previously measured according to the weight of the laundry.

3. The apparatus of claim 1, wherein the temperature correction coefficient is a pre-set value in order to make the temperature value detected by the temperature sensor the same as the actual temperature value of the laundry.

4. The apparatus of claim 1, wherein the temperature correcting unit corrects the temperature value detected by the temperature sensor by multiplying the pre-set temperature compensation coefficient to the weight value of the laundry and then adding the obtained value to the temperature value detected by the temperature sensor.

5. The apparatus of claim 1, wherein the temperature correcting unit corrects the temperature value detected by the temperature sensor installed in the washing machine based on the pre-set temperature correction coefficient in order to calculate an actual temperature value of the laundry in the washing machine.

6. The apparatus of claim 5, wherein the temperature correcting unit calculates the actual temperature value (T_{ci}) of the laundry through an equation of T_{ci}=Tᵢ+(Lᵢ×C) wherein Tᵢ is a temperature value currently detected by the temperature sensor, Lᵢ is a current weight value of the laundry, and ‘C’ is a pre-set temperature correction coefficient for compensating a difference value between the temperature value previously detected by the temperature sensor according to the weight of the laundry and the actual temperature value of the laundry previously measured according to the weight of the laundry.

7. The apparatus of claim 1, wherein the controller cuts off power being applied to the steam generating unit when the corrected temperature value reaches the pre-set reference temperature value.

8. An apparatus for controlling a steam generating unit of a washing machine comprising:
a temperature sensor installed at a lower side of a tub of the washing machine and detecting an ambient temperature;
a load amount calculating unit for calculating the weight of the laundry inside the washing machine;
a temperature correcting unit for correcting a temperature value detected by the temperature sensor so as to be the same as an actual temperature value of the laundry and outputting the corrected temperature value; and
a controller electrically connected with the steam generating unit for spraying steam into the washing machine and controlling the steam generating unit based on the corrected temperature value and a pre-set reference temperature value.

9. The apparatus of claim 8, wherein the controller cuts off power being applied to the steam generating unit when the corrected temperature value is reaches the pre-set reference temperature value.

10. The apparatus of claim 8, wherein, in order to reduce power consumption of the washing machine, when the corrected temperature value reaches the pre-set reference temperature value, the controller cuts off power being applied to the heater of the steam generating unit to prevent steam supply into the washing machine.

11. The apparatus of claim 8, wherein the temperature correcting unit calculates the actual temperature value of the laundry in the washing machine based on a temperature correction coefficient previously set according to the weight of the laundry in the washing machine and a temperature value detected by a temperature sensor installed in the washing machine.

12. The apparatus of claim 11, wherein the temperature correcting unit calculates the actual temperature value (T_{ci}) of the laundry through an equation of T_{ci}=Tᵢ+(Lᵢ×C) wherein Tᵢ is a temperature value currently detected by the temperature sensor, Lᵢ is a current weight value of the laundry, and ‘C’ is a pre-set temperature correction coefficient for compensating a difference value between the temperature value previously detected by the temperature sensor according to the weight of the laundry and the actual temperature value of the laundry previously measured according to the weight of the laundry.

13. A method for controlling a steam generating unit of a washing machine comprising:
calculating an actual temperature value of the laundry inside the washing machine based on a pre-set temperature correction coefficient according to the weight of the laundry inside the washing machine and a temperature value detected by a temperature sensor installed in the washing machine; and
controlling power applied to a steam generating unit in the washing machine based on the calculated temperature value and a pre-set reference temperature value.

14. The method of claim 13, wherein the temperature correction coefficient is a pre-set value in order to make the temperature value detected by the temperature sensor the same as the actual temperature value of the laundry.

15. The method of claim 13, wherein the step of calculating the actual temperature value of the laundry comprises:
multiplying the temperature compensation coefficient previously set according to the weight of the laundry to the weight value of the laundry; and
adding the obtained value to the temperature value detected by the temperature sensor.

16. The method of claim 13, wherein the actual temperature value (T_{ci}) of the laundry is calculated through an equation of T_{ci}=Tᵢ+(Lᵢ×C) wherein Tᵢ is a temperature value currently detected by the temperature sensor, Lᵢ is a current weight value of the laundry, and ‘C’ is a pre-set temperature correction coefficient for compensating a difference value between the temperature value previously detected by the temperature sensor according to the weight of the laundry and the actual temperature value of the laundry previously measured according to the weight of the laundry.

17. The method of claim 13, wherein, in the step of controlling power being applied to the steam generating unit, when the calculated actual temperature value reaches the pre-set reference temperature value, power being applied to the steam generating unit is cut off.

18. A method for controlling a steam generating unit of a washing machine, which includes a calculating unit for calculating the weight of the laundry received inside a drum of the washing machine, a temperature sensor installed at a lower side of a tub of the washing machine and detecting an ambient temperature when steam is sprayed into the drum, and a steam generating unit for spraying steam into the drum, the method comprising:
correcting a temperature value detected by the temperature sensor based on a temperature correction coefficient previously set according to the weight of the laundry in order to calculate an actual temperature of the laundry of the washing machine; and
cutting off power being applied to the steam generating unit when the corrected temperature value reaches a pre-set reference temperature value.

19. The method of claim 18, wherein the temperature correction coefficient is a pre-set value to be multiplied to a current weight value of the laundry in order to compensate a difference value between a temperature value previously detected by the temperature sensor according to the weight of the laundry and an actual temperature value of the laundry previously measured according to the weight of the laundry.
